(19) United States
(12) Patent Application Publication
(10) Pub. No.: US 2013/0224084 A1
(43) Pub. Date: Aug. 29, 2013

(54) OZONE GENERATING DEVICE

(71) Applicants: Joon-Hyung Lim, Yongin-si (KR); Jae-Sune Jun, Yongin-si (KR)

(72) Inventors: Joon-Hyung Lim, Yongin-si (KR); Jae-Sune Jun, Yongin-si (KR)

(73) Assignee: EPISOLUTIONS CO., LTD., Yongin-si, Gyeonggi-do (KR)

(21) Appl. No.: 13/884,441

(22) PCT Filed: Nov. 9, 2011
(86) PCT No.: PCT/KR2011/008521

§ 371 Date: May 15, 2013

(30) Foreign Application Priority Data
Nov. 9, 2010 (KR) 10-2010-0110797
Mar. 30, 2011 (KR) 10-2011-0028557

(51) Int. Cl. C01B 13/11

(52) U.S. Cl. CPC C01B 13/11
USPC 422/186.2

(57) ABSTRACT

An ozone generating device includes three or more cooling channels each having a through-hole formed in a central region thereof and a coolant flow path formed therein. The cooling channels are arranged side by side such that the through-holes thereof overlap with one another. The ozone generating device further includes electric discharge units interposed between the cooling channels adjoining each other and configured to generate electric discharge when applied with a high voltage. Each of the electric discharge units has a central hole formed in alignment with the through-hole. The ozone generating device is configured such that, when the electric discharge units are applied with a high voltage with the cooling channels kept grounded, oxygen supplied to the electric discharge units is decomposed into ozone which in turn is discharged through an internal space defined by the through-hole and the central hole.

### FIELD OF THE INVENTION

The present invention relates to an ozone generating device capable of generating an increased amount of ozone.

### BACKGROUND OF THE INVENTION

In recent years, ozone is increasingly used in a wide spectrum of fields. Along with this, research is extensively conducted on an ozone generating device and an ozone generating method. There are developed and known ozone generating devices having different structures.

Ozone generating methods include a silent discharge method, an electrolysis method, a photochemical reaction method, a radiation exposure method and a high-frequency electric field method. Among these methods, the silent discharge method is widely utilized due to its superiority in the efficiency, the performance stability and the ease of operation and control.

Ozone (O3), an allotrope of oxygen (O2), has a density 1.5 times as high as the density of oxygen and a water solubility 12.5 times as high as the water solubility of oxygen. Ozone does not leave any surplus material or any by-product except oxygen, an extremely small amount of carbon dioxide and water. Ozone can be generated by applying electric fields having a high enough voltage to between electrodes, generating ‘corona’ and passing a dry air or oxygen through the corona. Ozone has strong oxidizing power about 5.6 times as strong as the oxidizing power of chlorine and serves to improve the oxidation and cohesion effect of iron and manganese in a water treatment process

In addition, ozone can oxidize non-degradable materials and can convert the same to biodegradable materials. Particularly, ozone shows an instantaneous sterilizing action. The sterilizing power of ozone is known to be lower than that of fluorine (F) but 7 to 8 times as high as that of chlorine. Moreover, ozone has bleaching and deodorizing functions. After acting as a bleaching or deodorizing agent, ozone becomes an oxygen gas and comes into the air. The resultant water contains a large amount of oxygen and can be reused. Therefore, unlike other sterilizing solutions, ozone makes it unnecessary to wash a liquid adhering to a sterilizing vessel.

A conventional ozone generating device using a silent discharge method will now be described in detail with reference to the accompanying drawings.

FIG. 1 is an exploded section view showing a conventional ozone generating device. FIG. 2 is a section view of the conventional ozone generating device.

As shown in FIGS. 1 and 2, the conventional ozone generating device includes an electric discharge unit 10 for giving rise to an electric discharge phenomenon upon application of high-voltage high-frequency electric power, a grounding metal plate 20 mounted to the lower surface of the electric discharge unit 10, a pair of cover plates 30 arranged to surround the electric discharge unit 10 and the grounding metal plate 20 and a pair of cooling channels 40 attached to the outer surfaces of the cover plates 30, each of the cooling channels 40 having a coolant flow path 42 formed therein. The electric discharge unit 10 includes a pair of dielectrics 11 formed into a flat shape and arranged parallel to each other, a pair of conductive metal layers 12 attached to the mutually facing surfaces (hereinafter referred to as “inner surfaces”) of the dielectrics 11, a nonconductive epoxy layer 13 for combining the conductive metal layers 12 together and a spacer 16 for keeping one of the dielectrics 11 spaced apart from the grounding metal plate 20. At this time, if the conductive metal layers 12 are combined together only with the nonconductive epoxy layer 13, they cannot be electrically connected to each other. For that reason, one or more mounting holes 14 are formed in the nonconductive epoxy layer 13 and are filled with conductive epoxy resins 15. If the conductive metal layers 12 are combined together in a state that the conductive epoxy resins 15 are filled in the mounting holes 14, the conductive metal layers 12 make contact with the upper surfaces and the lower surfaces of the conductive epoxy resins 15, whereby the conductive metal layers 12 are electrically connected to each other.

After the respective components shown in FIG. 1 are combined together, a high voltage is applied to the conductive metal layers 12 with the grounding metal plate 20 kept grounded. Then, electric discharge is generated in a space between the lower dielectric 11 and the grounding metal plate 20. At this time, if oxygen is supplied into a space between the cover plates 30 through the use of an oxygen introduction pipe 60, the oxygen thus supplied is moved through a discharge space between the lower dielectric 11 and the grounding metal plate 20 and is transformed into ozone due to a change in its molecular bond structure. The ozone thus generated is discharged to the outside through an ozone exhaust pipe 70.

In the conventional ozone generating device configured as above, however, the oxygen introduction pipe 60 and the ozone exhaust pipe 70 are installed with respect to every electric discharge unit 10. Therefore, the conventional ozone generating device has a drawback in that the internal structure thereof becomes complex. In case where there is a need to generate an increased amount of ozone, it is necessary to provide a plurality of electric discharge units 10. In this case, the cover plates 30 and the cooling channels 40 need to be installed with respect to each of the electric discharge units 10. This poses a problem in that the overall size of the device grows larger and the configuration of the device becomes complex. Furthermore, an additional pipe on which the respective ozone exhaust pipes 70 converge is needed to collect the ozone generated from the electric discharge units 10. This presents a problem in that the configuration of the device becomes complex.

In the conventional ozone generating device having the structure shown in FIGS. 1 and 2, two cooling channels 40 are required in each of the electric discharge units 10. Also required are coolant supply pipes for supplying a coolant to the respective cooling channels 40 and coolant drain pipes for draining the coolant passing through the respective cooling channels 40. This poses a problem in that the manufacturing cost of the device grows higher and the amount of the coolant required becomes larger.

In the ozone generating device configured as above, the spacer 16 is essential in order to secure a space between one of the dielectrics 11 and the grounding metal plate 20. Thus, the manufacturing cost of the device is unavoidably increased due to the manufacture and assembly of the spacer 16. The ozone generating efficiency becomes higher as the gap between one of the dielectrics 11 and the grounding metal plate 20 grows smaller. Since there is a limitation in making the spacer 16 thin, a problem is posed in that a limitation exists in reducing the space between one of the dielectrics 11 and the grounding metal plate 20.

### SUMMARY OF THE INVENTION

### Technical Problems

In view of the problems noted above, it is an object of the present invention to provide an ozone generating device capable of generating an increased amount of ozone by the provision of a plurality of electric discharge units, realizing simplification of the device configuration and reduction of the device size despite the provision of a plurality of electric discharge units, and reducing the number of cooling channels to thereby simplify a coolant flow path and save the amount of a coolant used.

Another object of the present invention is to provide an ozone generating device capable of securing a space between a dielectric and a grounding metal plate without having to use a spacer, reducing the distance between the dielectric and the grounding metal plate, and realizing simplification of the device configuration and reduction of the device size despite the provision of a plurality of electric discharge units.

### Means for Solving the Problems

In order to achieve the above objects, the present invention provides an ozone generating device, including: three or more cooling channels each having a through-hole formed in a central region thereof and a coolant flow path formed therein, the cooling channels arranged side by side such that the through-holes thereof overlap with one another; and electric discharge units interposed between the cooling channels adjoining each other and configured to generate electric discharge when applied with a high voltage, each of the electric discharge units having a central hole formed in alignment with the through-hole, wherein the ozone generating device is configured such that, when the electric discharge units are applied with a high voltage with the cooling channels kept grounded, oxygen supplied to the electric discharge units is decomposed into ozone which in turn is discharged through an internal space defined by the through-hole and the central hole.

The ozone generating device may further include: a chamber arranged to accommodate the cooling channels and the electric discharge units therein; and an oxygen supply unit arranged to supply oxygen into the chamber.

The ozone generating device may further include: an ozone exhaust pipe arranged to be connected with the internal space defined by the through-hole and the central hole, the ozone exhaust pipe configured to gather the ozone generated by the electric discharge units and to discharge the ozone out of the chamber.

The ozone exhaust pipe may have a first end portion connected to the through-hole of the cooling channel positioned at one end of the ozone generating device and a second end portion extending out of the chamber, the through-hole of the cooling channel positioned at the other end of the ozone generating device kept closed.

The ozone generating device may further include: a coolant supply pipe parallel-connected to the cooling channels; and a coolant drain pipe parallel-connected to the cooling channels.

The cooling channels, the coolant supply pipe and the coolant drain pipe may be made of an electrically conductive metal and may be configured to serve as grounding terminals.

The cooling channels may be stacked such that a longitudinal direction of the through-hole extends along an up-down direction, each of the cooling channels having a planar upper surface and a planar lower surface, each of the electric discharge units formed into a flat shape.

Each of the electric discharge units may include a pair of dielectrics making contact with the mutually facing surfaces of the cooling channels adjoining each other and a conductive body arranged between the dielectrics.

Each of the electric discharge units may include a pair of dielectrics attached to or coated on the mutually facing surfaces of the cooling channels adjoining each other and a conductive body press-fitted to between the dielectrics.

Each of the electric discharge units may include a dielectric making contact with one of the mutually facing surfaces of the cooling channels adjoining each other and a conductive body arranged between the other of the mutually facing surfaces of the cooling channels adjoining each other and the dielectric.

Each of the electric discharge units may include a dielectric attached to or coated on one of the mutually facing surfaces of the cooling channels adjoining each other and a conductive body press-fitted to between the other of the mutually facing surfaces of the cooling channels adjoining each other and the dielectric.

The conductive body may have a surface facing the dielectric and having an arithmetical average roughness Ra of 0.1 to 100 μm.

The dielectric may have a surface facing conductive body and having an arithmetical average roughness Ra of 0.1 to 100 μm.

At least one of the mutually facing surfaces of the conductive body and the dielectric may be formed into a wavy shape.

Each of the electric discharge units may further include one or more spacers arranged between the conductive body and the dielectric so as to keep the conductive body and the dielectric spaced apart from each other.

Each of the spacers may be formed into a plate shape so as to cover the surface of the dielectric facing the conductive body, each of the spacers having an opening formed in alignment with the through-hole and a plurality of projections formed on the entire surface of each of the spacers facing the conductive body.

Each of the spacers may be formed into a plate shape so as to make contact with the dielectric and the conductive body, each of the spacers having a plurality of apertures and an opening formed in alignment with the through-hole.

Each of the electric discharge units may include a conductive body arranged between the cooling channels adjoining each other and one or more spacers inserted between the cooling channels and the conductive body so as to keep the cooling channels and the conductive body spaced apart from each other.

Each of the spacers may be formed into a plate shape so as to cover the surface of each of the cooling channels facing the conductive body, each of the spacers having an opening formed in alignment with the through-hole and a plurality of projections formed on the entire surface of each of the spacers facing the conductive body.

Each of the spacers may be formed into a plate shape so as to make contact with each of the cooling channels and the conductive body, each of the spacers having a plurality of apertures and an opening formed in alignment with the through-hole.

The conductive body may be slidably inserted between the cooling channels, each of the cooling channels including three or more stoppers for limiting an insertion distance of the conductive body, the stoppers arranged so as to make contact with front, left and right ends of the conductive body when the conductive body is inserted between the cooling channels.

Each of the cooling channels may include a seating concavity formed on a surface with which each of the spacers makes contact.

Furthermore, the present invention provides an ozone generating device, including: an electric discharge unit including a conductive body applied with a high voltage, a dielectric having one surface for covering the conductive body and a grounding plate for covering the other surface of the dielectric; and a cooling channel having a coolant flow path and making contact with the grounding plate, wherein the grounding plate includes projections formed on a surface of the grounding plate facing the dielectric so as to secure a space between the dielectric and the grounding plate.

The projections may be burrs formed on one surface of the grounding plate when the grounding plate is punched from the other surface of the grounding plate toward one surface thereof.

The burrs may be formed in multiple numbers at a regular interval on one surface of the grounding plate.

The projections may be protuberances formed on one surface of the grounding plate when the other surface of the grounding plate is subjected to embossing.

The protuberances may be formed in multiple numbers at a regular interval on one surface of the grounding plate.

The dielectric may include a pair of dielectrics arranged to cover the both surfaces of the conductive body, the grounding plate including a pair of grounding plates arranged to cover each dielectric.

The cooling channel may include three or more cooling channels each having a through-hole formed in a central region thereof, the cooling channels arranged side by side such that the through-holes thereof overlap with one another, the electric discharge unit including electric discharge units interposed between the cooling channels adjoining each other, each of the electric discharge units having a central hole formed in alignment with the through-hole, the ozone generating device configured such that, when the electric discharge units are applied with a high voltage, oxygen supplied to the electric discharge units is decomposed into ozone which in turn is discharged through an internal space defined by the through-hole and the central hole.

The ozone generating device may further include: a chamber arranged to accommodate the cooling channels and the electric discharge units therein; and an oxygen supply unit arranged to supply oxygen into the chamber.

The ozone generating device may further include: an ozone exhaust pipe arranged to be connected with the internal space defined by the through-hole and the central hole, the ozone exhaust pipe configured to gather the ozone generated by the electric discharge units and to discharge the ozone out of the chamber.

The ozone exhaust pipe may have a first end portion connected to the through-hole of the cooling channel positioned at one end of the ozone generating device and a second end portion extending out of the chamber, the through-hole of the cooling channel positioned at the other end of the ozone generating device kept closed.

The ozone generating device may further include: a coolant supply pipe parallel-connected to the cooling channels; and a coolant drain pipe parallel-connected to the cooling channels.

### Effects of the Invention

With the ozone generating device according to the present invention, the provision of a plurality of electric discharge units makes it possible to generate an increased amount of ozone. The omission of cover plates and an epoxy layer makes it possible to realize simplification of the device configuration and reduction of the device size. Since two electric discharge units are cooled by a single cooling channel, it is possible to simplify a coolant flow path and to save the amount of a coolant used.

With the ozone generating device according to the present invention, it is also possible to secure a space between a dielectric and a grounding metal plate without having to use a spacer, to reduce the distance between the dielectric and the grounding metal plate, and to realize simplification of the device configuration and reduction of the device size despite the provision of a plurality of electric discharge units.

### BRIEF DESCRIPTION OF THE DRAWINGS

FIG. 1 is an exploded section view showing a conventional ozone generating device.

FIG. 2 is a section view of the conventional ozone generating device.

FIG. 3 is a schematic view showing an ozone generating device according to a first embodiment of the present invention.

FIG. 4 is a plan view showing the arrangement structure of a cooling channel and electric discharge units included in the present ozone generating device.

FIG. 5 is a horizontal section view of the cooling channel included in the present ozone generating device.

FIG. 6 is an exploded perspective view of the electric discharge units included in the present ozone generating device.

FIGS. 7 and 8 are partial section views showing the coupling structure of the cooling channel and the electric discharge units included in the present ozone generating device.

FIG. 9 is a partial section view showing an ozone generating device according to a second embodiment of the present invention.

FIG. 10 is an exploded perspective view showing an electric discharge unit included in the ozone generating device according to the second embodiment of the present invention.

FIG. 11 is a perspective view showing a spacer included in an ozone generating device according to a third embodiment of the present invention.

FIG. 12 is a partial section view of the ozone generating device according to the third embodiment of the present invention.

FIG. 13 is a perspective view showing a spacer included in an ozone generating device according to a fourth embodiment of the present invention.

FIG. 14 is a partial section view of the ozone generating device according to the fourth embodiment of the present invention.

FIG. 15 is an exploded perspective view showing a cooling channel included in an ozone generating device according to a fifth embodiment of the present invention.

FIG. 16 is a bottom view showing a seating plate included in the ozone generating device according to the fifth embodiment of the present invention.

FIG. 17 is a section view showing a cooling channel included in the ozone generating device according to the fifth embodiment of the present invention.

FIG. 18 is a partial section view of the ozone generating device according to the fifth embodiment of the present invention.

FIG. 19 is an exploded perspective view showing an electric discharge unit and cooling channels included in an ozone generating device according to a sixth embodiment of the present invention.

FIGS. 20 and 21 are perspective and partial section views showing a grounding plate included in the ozone generating device according to the sixth embodiment of the present invention.

FIG. 22 is a horizontal section view showing a cooling channel included in the ozone generating device according to the sixth embodiment of the present invention.

FIG. 23 is an exploded section view showing an electric discharge unit and cooling channels included in the ozone generating device according to the sixth embodiment of the present invention.

FIG. 24 is a section view of the electric discharge unit and the cooling channels included in the ozone generating device according to the sixth embodiment of the present invention.

FIG. 25 is a perspective view showing a grounding plate included in an ozone generating device according to a seventh embodiment of the present invention.

FIG. 26 is a section view of the ozone generating device according to the seventh embodiment of the present invention.

FIG. 27 is an exploded perspective view showing an electric discharge unit and cooling channels included in an ozone generating device according to an eighth embodiment of the present invention.

FIG. 28 is a section view of the ozone generating device according to the eighth embodiment of the present invention.

### DETAILED DESCRIPTION OF EMBODIMENTS

Certain embodiments of an ozone generating device according to the present invention will now be described in detail with reference to the accompanying drawings.

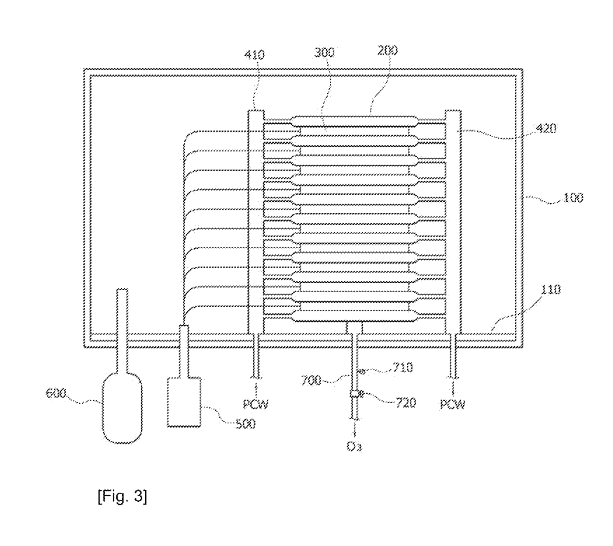

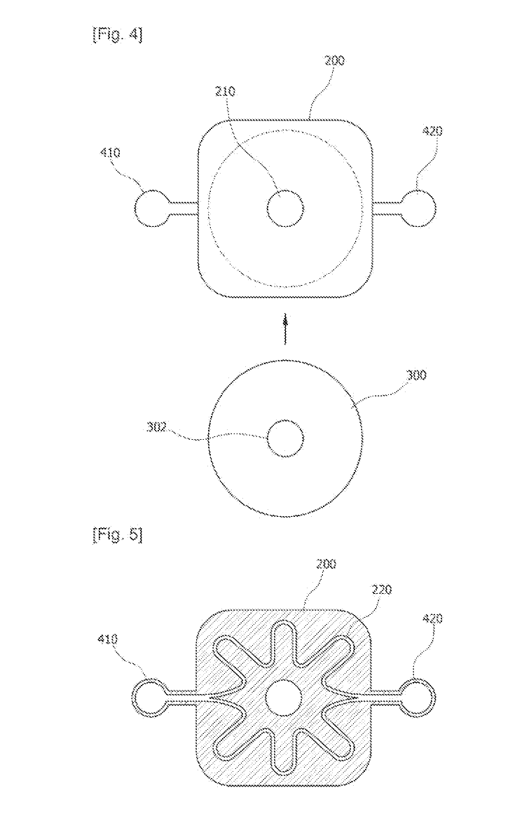

FIG. 3 is a schematic view showing an ozone generating device according to a first embodiment of the present invention. FIG. 4 is a plan view showing the arrangement structure of a cooling channel and electric discharge units included in the present ozone generating device. FIG. 5 is a horizontal section view of the cooling channel included in the present ozone generating device.

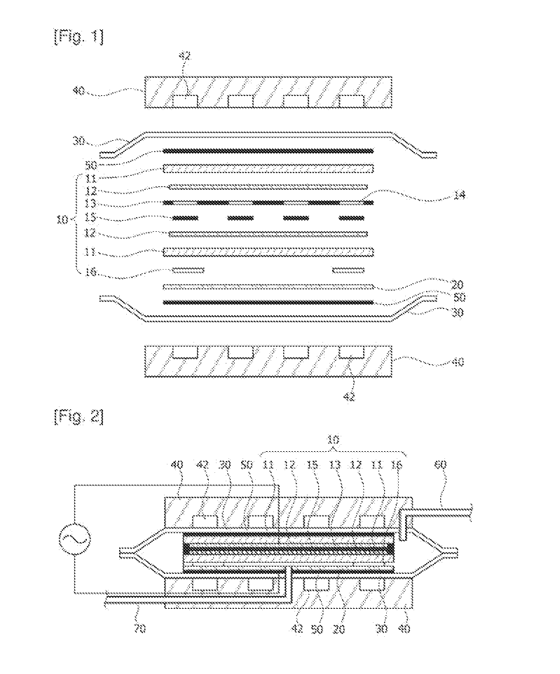

The present ozone generating device serves to generate ozone through the use of electric discharge units 300 that give rise to a discharge phenomenon when applied with a high voltage. One major features of the present ozone generating device resides in that the electric discharge units 300 are provided in multiple numbers so as to generate an increased amount of ozone at one time. The present ozone generating device is not a mere combination of the conventional ozone generating devices shown in FIGS. 1 and 2 but is simplified in the coupling structure of cooling channels 200 for cooling the electric discharge units 300 and in the structure of an ozone exhaust pipe 700 for discharging ozone, thereby providing an effect of reducing the device size and saving the manufacturing cost.

More specifically, the present ozone generating device includes three or more cooling channels 200 each having a through-hole 210 formed in a central region thereof and a coolant flow path 220 formed therein, the cooling channels 200 arranged such that the through-holes 210 thereof overlap with one another, and a plurality of electric discharge units 300 interposed between the cooling channels 200 adjoining each other and configured to perform a discharge operation upon receiving a high voltage from a power supply unit 500, each of the electric discharge units 300 having a central hole 302 formed in alignment with the through-hole 210. For the generation of ozone, the electric discharge units 300 need to be supplied with oxygen. Oxygen is supplied to the electric discharge units 300 through the lateral ends, i.e., the outer circumferential surfaces, of the electric discharge units 300. The ozone generated by the electric discharge units 300 is gathered in the central holes 302 of the electric discharge units 300. A process in which oxygen is transformed to ozone while passing through the electric discharge units 300 will be described later with reference to other drawings.

In the meantime, if the cooling channels 200 and the electric discharge units 300 are alternately stacked, the through-holes 210 are aligned with the central holes 302. As a result, a cylindrical columnar internal space defined by the through-holes 210 and the central holes 302 is formed in the central region of the stacked body of the cooling channels 200 and the electric discharge units 300. Thus, the ozone generated by the respective electric discharge units 300 is gathered in the internal space defined by the through-holes 210 and the central holes 302 and is discharged to the outside through the ozone exhaust pipe 700. At this time, it is preferred that the ozone exhaust pipe 700 be connected to the through-hole 210 of one of the cooling channels 200 positioned at one end (the lowermost cooling channel 200 in FIG. 3) so that the ozone exhaust pipe 700 can collect the ozone generated by the electric discharge units 300. If all the through-holes 210 of the cooling channels 200 remain opened upward and downward, there is likelihood that the ozone gathered in the space defined by the through-holes 210 and the central holes 302 is not discharged through the ozone exhaust pipe 700 but may be leaked through the through-hole 210 of the cooling channel 200 positioned at the opposite end from the ozone exhaust pipe 700 (the uppermost cooling channel 200 in FIG. 3). For that reason, it is desirable to close the through-hole 210 of the cooling channel 200 positioned at the other end (at the opposite end from the ozone exhaust pipe 700). Preferably, a pressure gauge 710 for measuring the pressure of the discharged ozone and a pressure regulator 720 for keeping the pressure of the discharged ozone constant are arranged in the ozone exhaust pipe 700.

As set forth above, the ozone generated by the electric discharge units 300 is gathered in a single space (the internal space defined by the through-holes 210 and the central holes 302). Therefore, the present ozone generating device has an advantage in that there is no need to employ additional flow paths and pipes for gathering the ozone generated by the respective electric discharge units 300. In the conventional ozone generating device shown in FIGS. 1 and 2, two cooling channels 40 need to be mounted to one electric discharge unit 10. This present a problem in that the number of parts grows larger and the configuration becomes complex. In the present ozone generating device, however, the electric discharge unit 300 positioned at the upper side and the electric discharge unit 300 positioned at the lower side are cooled by one cooling channel 200. Accordingly, it is possible to significantly reduce the number of the cooling channels 200. This provides an advantage of reducing the device size and saving the manufacturing cost.

In order to individually supply oxygen to the respective electric discharge units 300, there is a need to additionally provide cover plates for surrounding the electric discharge units 300. Furthermore, an oxygen supply pipe for supplying oxygen to the inside of each of the cover plates need to be attached to each of the cover plates. This is problematic in that the configuration becomes quite complex. In an effort to solve this problem, it is preferred that the present ozone generating device further includes a chamber 100 for accommodating the cooling channels 200 and the electric discharge units 300 and an oxygen supply unit 600 for supplying oxygen into the chamber 100.

If the cooling channels 200 and the electric discharge units 300 are arranged within the chamber 100 in this manner, oxygen can be supplied to all the electric discharge units 300 by merely introducing oxygen into the chamber 100. Thus it becomes easy to supply oxygen to the electric discharge units 300 and it becomes possible to omit the cover plates and the oxygen supply pipes. This provides an advantage of simplifying the configuration of the device. In this case, one end (the upper end in the present embodiment) of the ozone exhaust pipe 700 is connected to the through-holes 210 of the cooling channels 200. The other end (the lower end in the present embodiment) of the ozone exhaust pipe 700 extends out of the chamber 100 through the bottom of the chamber 100 so that the ozone generated by the respective electric discharge units 300 can be gathered and discharged out of the chamber 100. The chamber 100 includes a bottom insulation layer 110 for preventing a high-voltage current applied to the electric discharge units 300 from leaking to the outside.

A coolant flow path 220 through which a coolant can flow is formed inside each of the cooling channels 200. The present ozone generating device further includes a coolant supply pipe 410 for supplying a coolant to the respective cooling channels 200 therethrough and a coolant drain pipe 420 for training the coolant from the cooling channels 200. The coolant supply pipe 410 and the coolant drain pipe 420 are parallel connected to cooling channels 200. The coolant supplied through the coolant supply pipe 410 is distributed to all the cooling channels 200. The coolant heated while passing through the respective cooling channels 200 is gathered in the coolant drain pipe 420 and then drained out of the chamber 100. Accordingly, there is no need to supply the coolant to the respective cooling channels 200 one by one. By merely supplying the coolant to the coolant supply pipe 410, it becomes possible to evenly deliver to the respective cooling channels 200. Since the coolant passing through the respective cooling channels 200 is gathered in the coolant drain pipe 420 and then drained from the coolant drain pipe 420 to the outside, it is possible to easily deal with the coolant used.

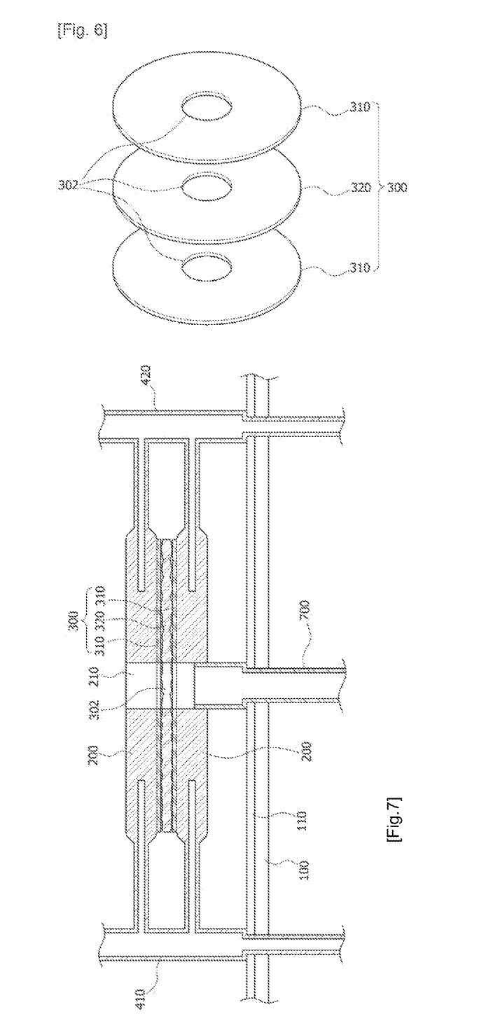

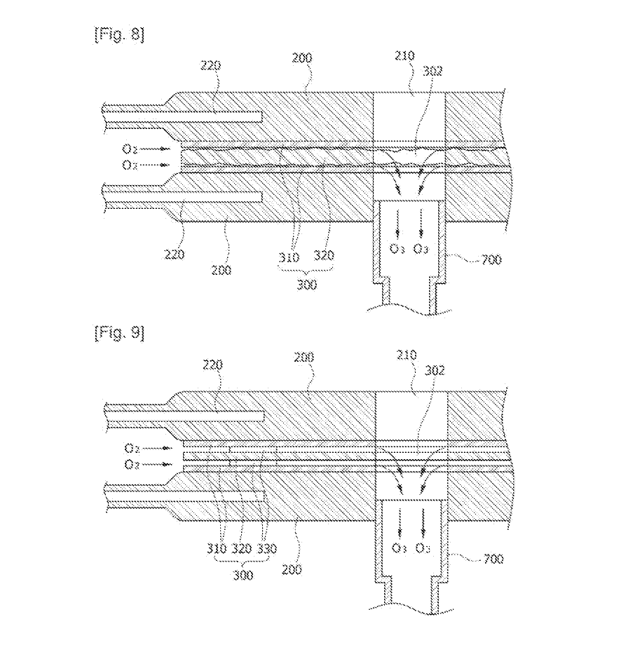

FIG. 6 is an exploded perspective view of the electric discharge units 300 included in the present ozone generating device. FIGS. 7 and 8 are partial section views showing the coupling structure of the cooling channels 200 and the electric discharge units 300 included in the present ozone generating device.

The electric discharge units 300 of the present ozone generating device may have any structure as long as they can give rise to an electric discharge phenomenon when applied with a high voltage. In other words, the electric discharge units 300 may be configured to perform either a silent discharge operation or a corona discharge operation. As representatively described herein below, each of the electric discharge units 300 of the present embodiment includes dielectrics 310 and a conductive body 320 and serves to perform a silent discharge operation. Since the central hole 302 communicating with the through-holes 210 of the cooling channels 200 is formed in the central region of each of the electric discharge units 300, it is necessary to form central holes 302 in the central regions of the dielectrics 310 and in the central region of the conductive body 320.

The cooling channels 200 and the electric discharge units 300 can be stacked in many different directions. In order to keep the stacking state stable, it is preferred that, as in the present embodiment, the cooling channels 200 and the electric discharge units 300 are stacked in an up-down direction so that the longitudinal direction of the through-holes 210 and the central holes 302 can extend along the up-down direction. At this time, it is preferred that the electric discharge units 300 are press-fitted between the cooling channels 200 so that the electric discharge units 300 can be stably maintained between the cooling channels 200 without having to use an adhesive agent such as an epoxy resin or the like. In order to keep the contact area between the cooling channels 200 and the electric discharge units 300 as broad as possible, it is preferred that the upper surfaces and the lower surfaces of the cooling channels 200 are formed into a planar shape and the electric discharge units 300 are formed into a flat shape.

In case where each of the electric discharge units 300 is formed of a pair of dielectrics 310 and a single conductive body 320 as shown in FIGS. 7 and 8, a small space need to be left between the conductive body 320 and each of the dielectrics 310 so that electric discharge can be generated when a high voltage is applied to the conductive body 320. If the upper surfaces and the lower surfaces of the dielectrics 310 and the conductive body 320 are formed into a smooth planar surface, it is impossible to secure spaces between the dielectrics 310 and the conductive body 320. This presents a problem in that oxygen cannot pass through between the dielectrics 310 and the conductive body 320.

The upper surface and the lower surface of the conductive body 320 are processed to have an arithmetical average roughness Ra falling within a specified range so that spaces can be secured between the conductive body 320 and the dielectrics 310. At this time, if the upper surface and the lower surface of the conductive body 320 are too low in average roughness, there is likelihood that a large enough space is not secured between each of the dielectrics 310 and the conductive body 320, thereby hindering normal generation of electric discharge. If the upper surface and the lower surface of the conductive body 320 are too high in average roughness, the space between each of the dielectrics 310 and the conductive body 320 becomes too large and the capacitance becomes too small. This may reduce the ozone generation amount. Accordingly, it is preferred that the upper surface and the lower surface of the conductive body 320 are processed to have an arithmetical average roughness Ra of 0.1 to 100 μm.

If a space is secured between each of the dielectrics 310 and the conductive body 320, the oxygen supplied to the lateral ends of the electric discharge units 300 is introduced into the spaces between the conductive body 320 and the dielectrics 310. The oxygen can flow toward the space defined by the through-holes 210 and the central holes 302. If a high voltage is applied to the conductive body 320 in a state that the oxygen is introduced into the spaces between the conductive body 320 and the dielectrics 310, the oxygen is transformed to ozone through decomposition and recombination processes and is then collected in the ozone exhaust pipe 700. With the present ozone generating device configured as above, the ozone generated by the respective electric discharge units 300 is gathered in the space defined by the through-holes 210 and the central holes 302 and is then discharged to the outside through the ozone exhaust pipe 700. It is therefore possible to omit ozone flow pipes for gathering the ozone thus generated. This provides an advantage of simplifying the device configuration. In particular, if the ozone generating device is configured to close the through-hole 210 of the cooling channel 200 positioned at the uppermost side, the total amount of the ozone generated by the respective electric discharge units 300 is gathered in the ozone exhaust pipe 700. This makes it possible to obtain an increased amount of ozone. If steps are formed in the borders between the through-holes 210 and the central holes 302, the ozone cannot smoothly flow toward the ozone exhaust pipe 700. For that reason, it is preferred that the inner circumferential surfaces of the through-holes 210 are flush with the inner circumferential surfaces of the central holes 302. In other words, the through-holes 210 and the central holes 302 should be formed to have the same size and should be arranged such that the center axes thereof coincide with each other.

In the present embodiment, the spaces between the conductive body 320 and the dielectrics 310 are secured by roughening the surfaces of the conductive body 320. Alternatively, the spaces between the conductive body 320 and the dielectrics 310 may be secured by smoothening the surfaces of the conductive body 320 and roughening the surfaces of the dielectrics 310. In case where the dielectrics 310 are roughened in this manner, it is preferred that the surfaces of the dielectrics 310 facing the conductive body 320 are processed to have an arithmetical average roughness Ra of 0.1 to 100 μm.

Many other methods than the method of roughening the conductive body 320 or the dielectrics 310 may be used to secure the spaces between the conductive body 320 and the dielectrics 310. For example, instead of processing the mutually facing surfaces of the conductive body 320 and the dielectrics 310 into a planar shape, at least one of the mutually facing surfaces may be formed to have a wavy shape so that oxygen can flow through between the conductive body 320 and the dielectrics 310. In this case, the curvature of the wavy surface is appropriately set depending on the size of the spaces to be secured between the conductive body 320 and the dielectrics 310.

The cooling channels 200, the coolant supply pipe 410 and the coolant drain pipe 420 may be made of an electrically conductive metal so as to serve as grounding terminals. In this case, it becomes possible to omit the grounding metal plate 20 shown in FIGS. 1 and 2. This provides an advantage in that the configuration of the ozone generating device becomes simple.

While the dielectrics 310 are detachable from the cooling channels 200 in the present embodiment, the dielectrics 310 may be fixedly secured to the cooling channels 200. In other words, the dielectrics 310 may be fixed to or coated on the mutually facing surfaces of the cooling channels 200 adjoining each other. The conductive body 320 may be press-fitted between the dielectrics 310. If the dielectrics 310 are one-piece formed with the cooling channels 200 in this manner, each of the electric discharge units 300 can be mounted by merely inserting the conductive body 320 between the dielectrics 310. This provides an advantage in that the ozone generating device can be manufactured with ease. In particular, if the dielectrics 310 are coated on the cooling channels 200, the dielectrics 310 can be formed and combined through a single coating step without having to perform the step of manufacturing the dielectrics 310 and the step of combining the dielectrics 310 with the cooling channels 200. This provides an advantage in that the manufacturing process of the ozone generating device becomes very simple.

While the dielectrics 310 are provided in pair so as to cover the upper surface and the lower surface of the conductive body 320 in the present embodiment, only one dielectric 310 may be provided with respect to the corresponding conductive body 320. In other words, each of the electric discharge units 300 may include a dielectric 310 making contact with one of the mutually facing surfaces of the cooling channels 200 adjoining each other and a conductive body 320 arranged between the other of the mutually facing surfaces of the cooling channels 200 and the dielectric 310. If each of the electric discharge units 300 is configured in this manner such that one surface of the conductive body 320 makes contact with the dielectric 310 and the other surface of the conductive body 320 makes contact with one of the cooling channels 200, ozone is generated only between one surface of the conductive body 320 and the dielectric 310. Thus, the amount of the ozone generated becomes a little smaller. However, this provides an advantage of greatly simplifying the configuration of the device and reducing the manufacturing cost of the device. Accordingly, it is possible for a manufacturer to mount a pair of dielectrics 310 or a single dielectric 310 depending on the intended use of the present ozone generating device.

In case where only one dielectric 310 is provided as set forth above, the dielectric 310 may be fixed to or coated on one of the mutually facing surfaces of the cooling channels 200 adjoining each other. In this case, the conductive body 320 needs to be press-fitted between the other of the mutually facing surfaces of the cooling channels 200 and the dielectric 310.

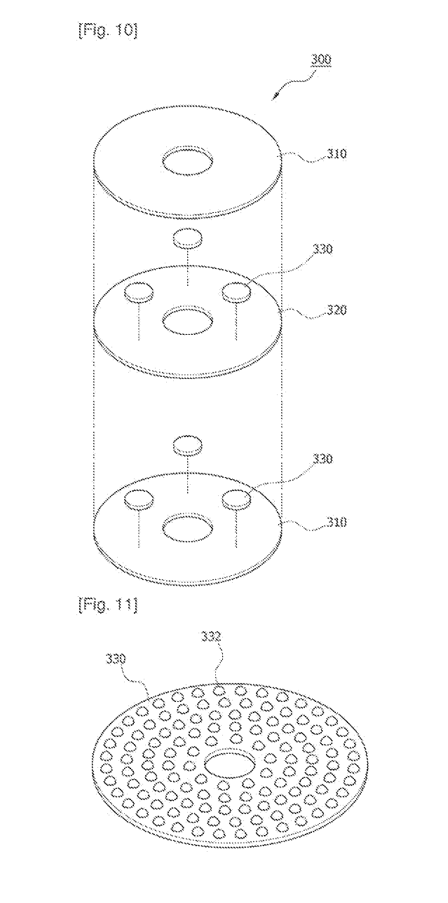

FIG. 9 is a partial section view showing an ozone generating device according to a second embodiment of the present invention. FIG. 10 is an exploded perspective view showing an electric discharge unit included in the ozone generating device according to the second embodiment of the present invention.

Each of the electric discharge units 300 included in the ozone generating device according to the second embodiment of the present invention may further include one or more spacers 330 arranged between the conductive body 320 and the dielectrics 310 as shown in FIGS. 9 and 10 so that spaces can be secured between the dielectrics 310 and the conductive body 320. In this case, there is no need to roughen the surfaces of the conductive body 320. If the spacers 330 are additionally provided between the conductive body 320 and the dielectrics 310, spaces having a dimension corresponding to the thickness of the spacers 330 are secured between the conductive body 320 and the dielectrics 310. Thus, the oxygen supplied to the lateral end of each of the electric discharge units 300 can flow along the spaces existing between conductive body 320 and the dielectrics 310. In the event that the spaces between the conductive body 320 and the dielectrics 310 are secured by roughening the surfaces of the conductive body 320 as in the embodiment shown in FIGS. 7 and 8, the roughness of the surfaces of the conductive body 320 may differ from region to region. This makes it impossible to accurately adjust the dimension of the spaces defined between the conductive body 320 and the dielectrics 310. In contrast, if the conductive body 320 and the dielectrics 310 are spaced apart from each other through the use of the spacers 330, there is provided an advantage in that the dimension of the spaces defined between the conductive body 320 and the dielectrics 310 can be accurately adjusted by precisely setting the thickness of the spacers 330.

Needless to say, if the spaces between the conductive body 320 and the dielectrics 310 are secured by roughening the surfaces of the conductive body 320, there is no need to employ additional components for securing the spaces. This helps reduce the manufacturing cost. Accordingly, the methods of securing the spaces between the conductive body 320 and the dielectrics 310 can be arbitrarily selected depending on the intended use and conditions of the ozone generating device.

In case where the spaces through which oxygen can pass are secured through the use of the spacers 330, the conductive body 320 does not make direct contact with the cooling channels 200 even if the dielectrics 310 are removed. This makes it possible to omit the dielectrics 310. In other words, each of the electric discharge units 300 may include a conductive body 320 arranged between the two cooling channels 200 adjoining each other and one or more spacers 330 arranged between the cooling channels 200 and the conductive body 320 so as to keep the cooling channels 200 and the conductive body 320 spaced apart from each other. Even if the dielectrics 310 do not exist between the conductive body 320 applied with a high voltage and the cooling channels 200 serving as grounding terminals, electric discharge can be generated between the conductive body 320 and the cooling channels 200. Thus, ozone can be generated by the electric discharge.

FIG. 11 is a perspective view showing a spacer included in an ozone generating device according to a third embodiment of the present invention. FIG. 12 is a partial section view of the ozone generating device according to the third embodiment of the present invention.

If the cooling channels 200 and the conductive bodies 320 are stacked one above another in multiple numbers, the cooling channels 200 and the conductive body 320 positioned at the lower side may undergo sagging due to the load of the cooling channels 200 and the conductive bodies 320 positioned at the upper side. In this case, if the spacers 330 are formed into the shape as shown in FIGS. 9 and 10, the height of the spaces between the dielectrics 310 and the conductive body 320 may differ from region to region due to the sagging of the cooling channels 200 and the conductive body 320. In other words, the height of the spaces between the dielectrics 310 and the conductive body 320 are substantially equal to the thickness of the spacers 330 at the points adjacent to the spacers 330. However, due to the sagging of the cooling channels 200 and the conductive body 320, the height of the spaces between the dielectrics 310 and the conductive body 320 becomes smaller than the thickness of the spacers 330 at the points distant from the spacers 330. This poses a problem in that the electric discharge level may differ from point to point.

In order to solve the problem noted above, as shown in FIGS. 11 and 12, the spacers 330 employed in the ozone generating device of the present embodiment may be formed into a plate shape capable of covering the surfaces of the dielectrics 310 facing the conductive body 320 (the lower surface of the upper dielectric 310 and the upper surface of the lower dielectric 310). In this case, each of the spacers 330 has an opening formed in alignment with the through-hole 210 so that the ozone generated between the conductive body 320 and the dielectrics 310 can be discharged to the ozone exhaust pipe 700 through the through-hole 210. A plurality of projections 332 is formed on the surfaces of the spacers 330 (the lower surface of the upper spacer 330 and the upper surface of the lower spacer 330). Thus, spaces having a dimension equal to the height of the projections 332 are secured between the conductive body 320 and the dielectrics 310. If each of the spacers 330 is formed into a plate shape so as to have a plurality of projections 332 as set forth above, the respective projections 332 can evenly support the load of the cooling channels 200 and the dielectrics 310 positioned at the upper side. Thus, no sagging is generated in the cooling channels 200 and the dielectrics 310. As a result, there is provided an advantage in that the height of the spaces existing between the dielectrics 310 and the conductive body 320 becomes even in the respective regions.

In addition, if the spacers 330 are formed into a small coin size as shown in FIGS. 9 and 10, it is necessary to accurately arrange the respective spacers 330 as a regular interval. This presents a drawback in that an increased amount of time is required in mounting the spacers 330. In contrast, if each of the spacers 330 is one-piece formed into a large plate shape as shown in FIGS. 11 and 12, there is an advantage in that the spacers 330 can be mounted with ease.

While the plate-shaped spacers 330 each provided with a plurality of projections 330 are employed in each of the electric discharge units 300 of the present embodiment including the dielectrics 310 and the conductive body 320, it may be possible to apply the plate-shaped spacers 330 to each of the electric discharge units 300 having no dielectric 310. In other words, each of the spacers 330 may be formed into a plate shape so as to cover the surfaces of the cooling channels 200 facing the conductive body 320 and may be configured to include a plurality of projections 332 making contact with the conductive body 320. Even if the dielectrics 310 do not exist between the conductive body 320 applied with a high voltage and the cooling channels 200 serving as grounding terminals, electric discharge can be generated as long as spaces are secured between the conductive body 320 and the cooling channels 200. Thus, ozone can be generated by the electric discharge.

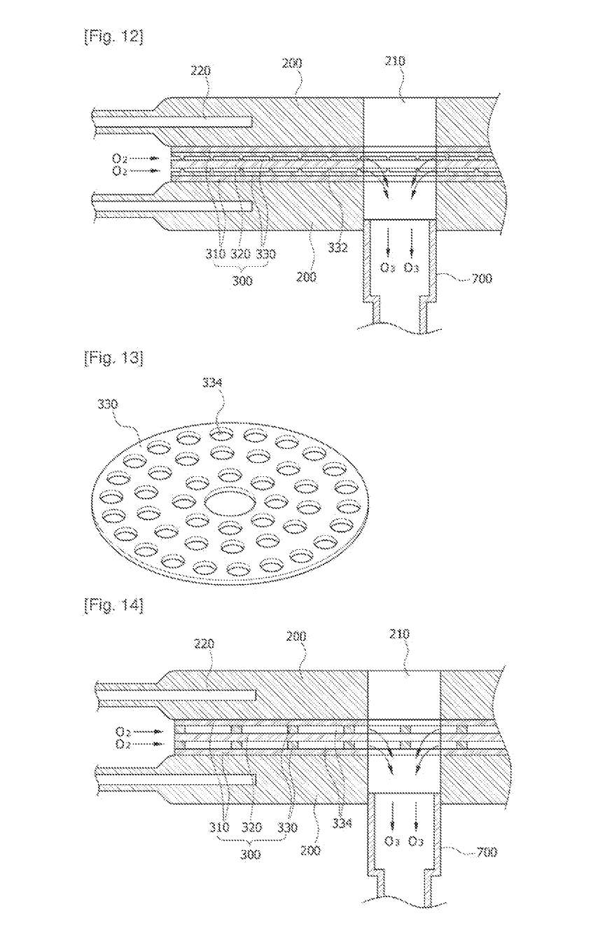

FIG. 13 is a perspective view showing a spacer included in an ozone generating device according to a fourth embodiment of the present invention. FIG. 14 is a partial section view of the ozone generating device according to the fourth embodiment of the present invention.

As shown in FIGS. 13 and 14, each of the spacers 330 may be formed into a plate shape so as to make contact with the dielectrics 310 and the conductive body 320 and may be configured to include a plurality of apertures 334. With this configuration, when the spacers 330 are inserted between the dielectrics 310 and the conductive body 320, the internal spaces of the apertures 334 serve to keep the dielectrics 310 and the conductive body 320 spaced apart from each other. Thus, electric discharge is generated in the internal spaces of the apertures 334.

If each of the spacers 330 is formed into a plate shape so as to have a plurality of apertures 334, there is provided an advantage in that the cooling channels 200, the dielectrics 310 and the conductive body 320 can be stably stacked one above another.

While the plate-shaped spacers 330 each provided with a plurality of apertures 334 are employed in each of the electric discharge units 300 of the present embodiment including the dielectrics 310 and the conductive body 320, it may be possible to apply the plate-shaped spacers 330 to each of the electric discharge units 300 having no dielectric 310. In other words, each of the spacers 330 may be formed into a plate shape so as to make direct contact with the cooling channels 200 and the conductive body 320 and may be configured to include a plurality of apertures 334.

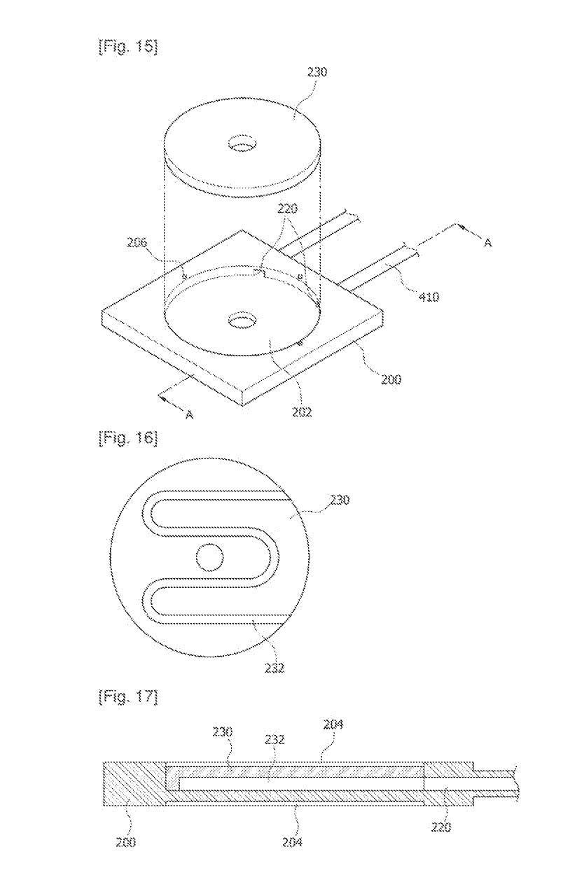

FIG. 15 is an exploded perspective view showing a cooling channel included in an ozone generating device according to a fifth embodiment of the present invention. FIG. 16 is a bottom view showing a seating plate included in the ozone generating device according to the fifth embodiment of the present invention. FIG. 17 is a section view showing a cooling channel included in the ozone generating device according to the fifth embodiment of the present invention. FIG. 18 is a partial section view of the ozone generating device according to the fifth embodiment of the present invention.

In order to easily form a coolant flow path 220, the cooling channel 200 of the ozone generating device according to the fifth embodiment has an upwardly opened recess 202 to which the coolant supply pipe 410 is connected. The cooling channel 200 is configured to include a seating plate 230 having a downwardly opened flow path groove 232 to which the coolant supply pipe 410 is connected. The seating plate 230 is fitted to the recess 202.

In this case, the thickness of the seating plate 230 is set a little smaller than the depth of the recess 202. Thus, when the seating plate 230 is fitted to the recess 202, a seating concavity 204 in which the spacer 330 is partially received as shown in FIG. 18 is defined by the upper surface of the seating plate 230 and the inner circumferential surface of the recess 202. If the spacer 330 is partially received in the seating concavity 204, there is provided an advantage in that the spacer 330 kept immovable when the conductive body 320 is pushed into between the spacers 330 and pulled out from between the spacers 330. In other words, when the conductive body 320 is replaced with a new one, there is no possibility that the spacers 330 are removed or inserted together with the conductive body 320. This provides an advantage in that the conductive body 320 can be replaced with ease.

An additional seating concavity 204 for partially receiving the spacer 330 is formed on the opposite surface of the cooling channel 200 from the recess 202, namely on the lower surface of the cooling channel 200. The additional seating concavity 204 is formed on the lower surface of the cooling channel 200 by way of a separate machining process. As stated above, the seating concavity 204 may be defined by the seating plate 230 and the recess 202 or may be formed by machining the cooling channel 200. Accordingly, the seating concavity 204 can be applied to not only the embodiment shown in FIGS. 15 through 18 but also the embodiment shown in FIGS. 12 and 14.

When the conductive body 320 is slidably inserted in the aforementioned manner, it is difficult to know how deep the conductive body 320 is inserted. Thus, a difficulty is encountered in positioning the conductive body 320 in a right position. In view of this, as shown in FIG. 15, the cooling channel 200 may further include a plurality of stoppers 206 for limiting the insertion distance of the conductive body 320. In order to prevent the conductive body 320 from being excessively inserted forward or moved to the left or the right when the conductive body 320 is fitted between the spacers 330, the stoppers 206 are preferably provided at three points, namely at the front, left and right ends of the cooling channel 200.

The stoppers 206 can be applied to not only the structure shown in FIG. 15 but also the embodiment shown in FIGS. 12 and 14. In case where the stoppers 206 are applied to the embodiment shown in FIGS. 12 and 14, they serve to limit not only the insertion position of the conductive body 320 but also the insertion positions of the spacers 330.

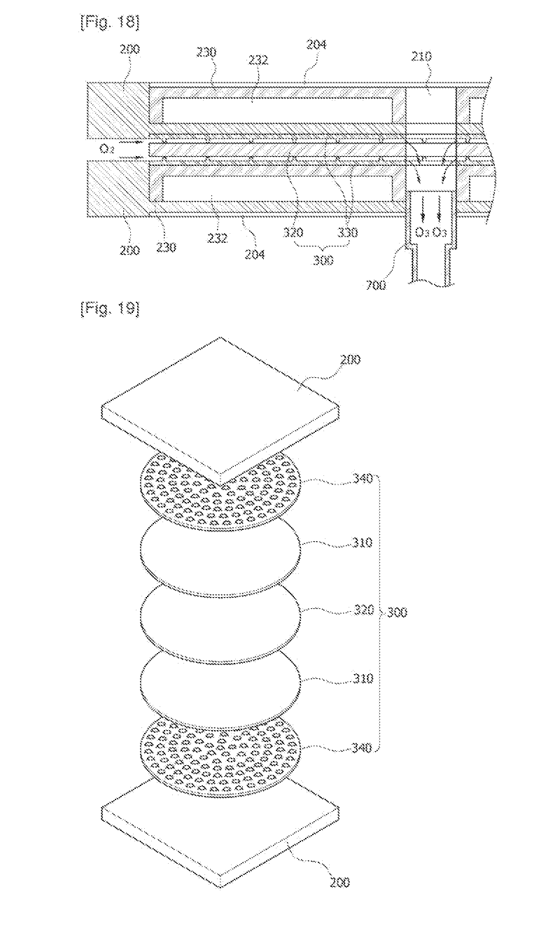

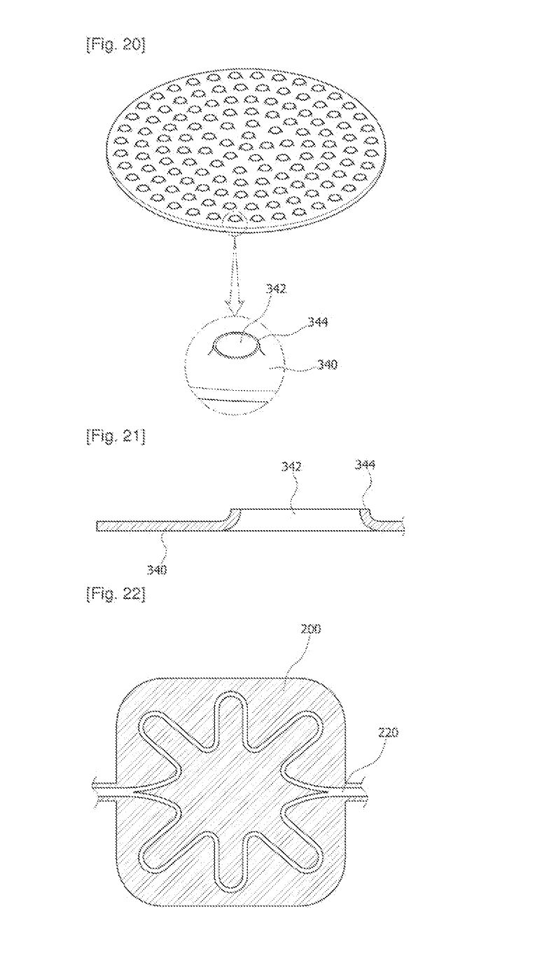

FIG. 19 is an exploded perspective view showing an electric discharge unit and cooling channels included in an ozone generating device according to a sixth embodiment of the present invention. FIGS. 20 and 21 are perspective and partial section views showing a grounding plate included in the ozone generating device according to the sixth embodiment of the present invention. FIG. 22 is a horizontal section view showing a cooling channel included in the ozone generating device according to the sixth embodiment of the present invention.

In the ozone generating device according to the sixth embodiment, the cooling channels 200 do not serve as grounding terminals. Instead, the ozone generating device further includes a component serving as a grounding terminal. More specifically, each of the electric discharge units 300 included in the ozone generating device of the sixth embodiment includes a conductive body 320 applied with a high voltage, dielectrics 310 arranged to cover the upper surface and the lower surface of the conductive body 320 and grounding plates 340 arranged to cover the outer surfaces of the dielectrics 310, namely the upper surface of the upper dielectric 310 and the lower surface of the lower dielectric 310.

If the grounding plates 340 are additionally provided as in the present embodiment, spaces can be formed between the dielectrics 310 and the grounding plates 340 so that electric discharge can be generated in the spaces. In this case, projections are formed on one surface of each of the grounding plates 340 facing the dielectrics 310 so that spaces can be secured between the dielectrics 310 and the grounding plates 340 with no use of additional spacers. If the projections are formed in the grounding plates 340, spaces having a dimension substantially equal to the height of the projections can be secured between the mutually facing surfaces of the dielectrics 310 and the grounding plates 340 without having to mount additional spacers between the dielectrics 310 and the grounding plates 340. This provides an advantage in that it becomes possible to realize simplification of the manufacturing process and the device configuration through the reduction of component number and to reduce the size of the device.

The projections of the grounding plates 340 can be formed by plastically processing the grounding plates 340. However, the plastic processing method is problematic in that it is difficult to accurately form the projections. In other words, a typical plastic processing method is capable of forming projections having a height of several centimeters or several millimeters but is hard to form projections having a height of several tens micrometers. Therefore, it is quite difficult to set the dimension of the spaces between the grounding plates 340 and the dielectrics 310 in an order of micrometers.

In order to solve the aforementioned problem, burrs 344 formed by punching the grounding plates 340 are used as the projections in the ozone generating device of the present embodiment. The burrs 344 formed by punching a metal plate have different sizes depending on the properties of the metal plate and the characteristics of a punch. If the properties of the metal plate and the characteristics of the punch are kept constant, it is possible to keep constant the height of the burrs 344. The height of the burrs 344 is usually as large as several tens micrometers. Therefore, if the burrs 344 are used as the projections as stated above, it is possible to accurately set the height of the spaces between the dielectrics 310 and the grounding plates 340 in an order of several tens micrometers. Since the burrs 344 need to be formed on one surface of each of the grounding plates 340 facing the dielectrics 310, the punching direction is set to face from the other surface of each of the grounding plates 340 toward one surface thereof.

It is preferred that the burrs 344 are formed in multiple numbers at a regular interval on one surface of each of the grounding plates 340 so that the spaces between the dielectrics 310 and the grounding plates 340 can be easily secured in all the regions. In order to form the burrs 344, it is necessary to form a plurality of apertures 342 in each of the grounding plates 340. The formation of the apertures 342 reduces the weight of the grounding plates 340. This helps reduce the weight of the ozone generating device. Since the heat generated in the discharge spaces is directly transferred to the cooling channels 200 through the apertures 342, there is an advantage in that the heat dissipation performance grows higher.

While the conductive body 320 is arranged at the center with the dielectrics 310 and the grounding plates 340 stacked at the upper and lower sides of the conductive body 320 in the present embodiment, the dielectrics 310 and the grounding plates 340 may be stacked only at the upper side of the conductive body 320 or only at the lower side of the conductive body 320. If the dielectrics 310 and the grounding plates 340 are stacked at the upper and lower sides of the conductive body 320, two discharge spaces are secured in one electric discharge unit 300. This provides an advantage in that it becomes possible to generate an increased amount of ozone. Accordingly, the number of the dielectrics 310 and the grounding plates 340 can be arbitrarily changed depending on the characteristics and intended use of the ozone generating device.

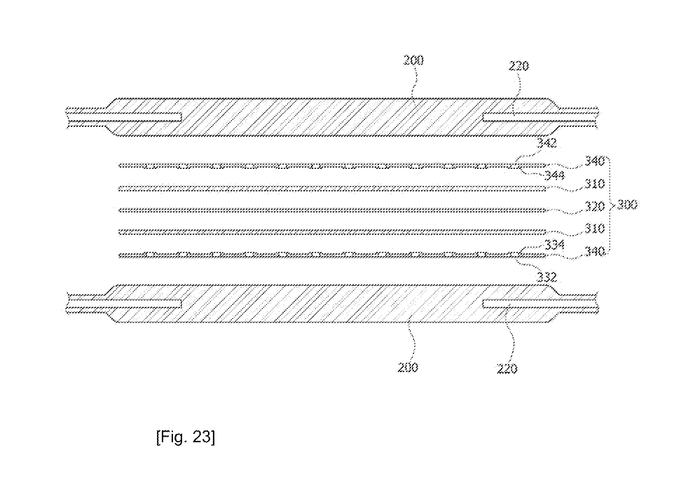

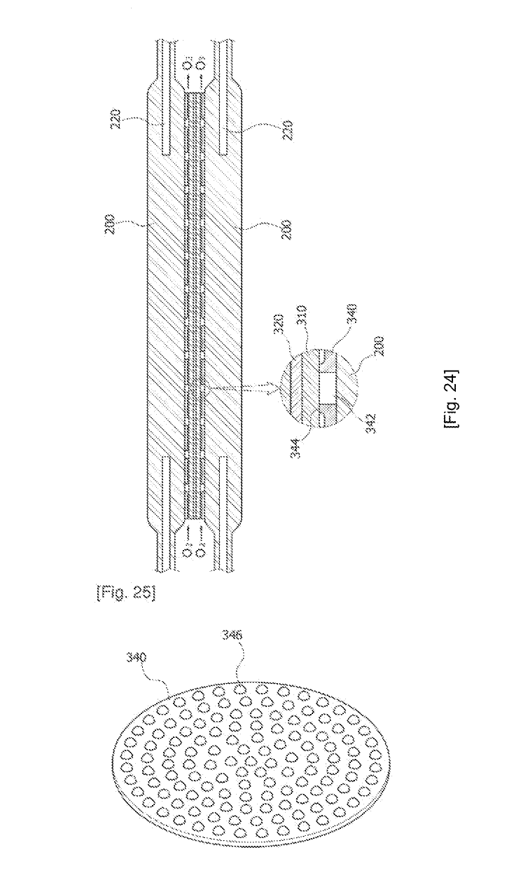

FIG. 23 is an exploded section view showing an electric discharge unit and cooling channels included in the ozone generating device according to the sixth embodiment of the present invention. FIG. 24 is a section view of the electric discharge unit and the cooling channels included in the ozone generating device according to the sixth embodiment of the present invention.

In the ozone generating device of the sixth embodiment, as shown in FIGS. 23 and 24, spaces are secured between the dielectrics 310 and the grounding plates 340 by the burrs 344 formed in the grounding plates 340. Therefore, the oxygen supplied from one lateral side of the electric discharge unit 300 (from the left side in FIG. 24) is transformed to ozone while passing through the spaces between the dielectrics 310 and the grounding plates 340. Then, the ozone is discharged to the other side of the electric discharge unit 300 (to the right side in FIG. 24).

The burrs 344 formed in the process of punching the grounding plates 340 have a very small height. If the spaces between the dielectrics 310 and the grounding plates 340 are narrowly secured through the use of the burrs 344 formed in the grounding plates 340, there is an advantage of increasing the ozone generation effect.

Since the height of the burrs 344 is increased or decreased depending on the different conditions such as the material of the grounding plates 340, the punching speed and so forth, the distance between the dielectrics 310 and the grounding plates 340 can be changed by appropriately selecting the kind of the grounding plates 340 or the process of forming the apertures 342 in the grounding plates 340.

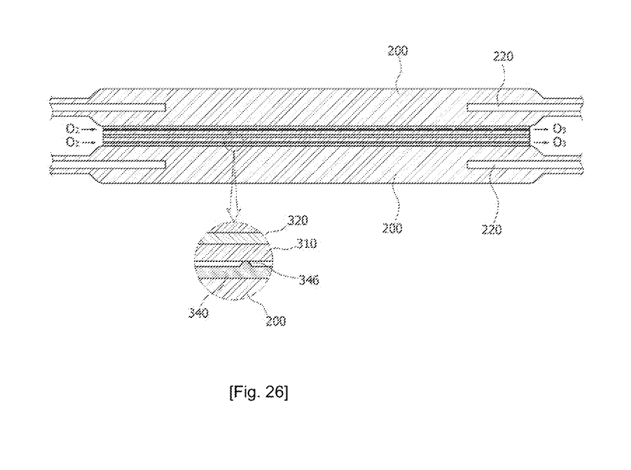

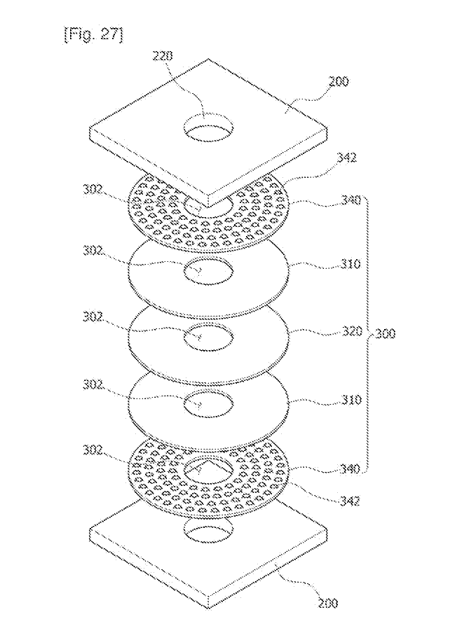

FIG. 25 is a perspective view showing a grounding plate 340 included in an ozone generating device according to a seventh embodiment of the present invention. FIG. 26 is a section view of the ozone generating device according to the seventh embodiment of the present invention.

The projections described above may be either the burrs 344 formed by punching as in the embodiment shown in FIGS. 19 through 24 or protuberances 346 formed on one surface of each of the grounding plates 340 by embossing or pressing the other surface of each of the grounding plates 340 as in the embodiment shown in FIGS. 25 and 26.

The height of the protuberances 346 formed by embossing is hard to be set as small as several micrometers. Therefore, as compared with the embodiment shown in FIGS. 19 through 24, the gap between the dielectrics 310 and the grounding plates 340 becomes relatively large in the embodiment shown in FIGS. 25 and 26. However, the protuberances 346 provide an advantage in that it becomes relatively easy to form the projections and to reduce the likelihood of deformation or damage of the projections caused by a vertical compression force. Accordingly, if there is a need to set the distance between the dielectrics 310 and the grounding plates 340 as large as several millimeters, it is preferable to use the protuberances 346 shown in FIGS. 25 and 26.

In case where the protuberances 346 are used as the protrusions, it is preferable to form a plurality of protuberances 346 on one surface of each of the grounding plates 340 at a regular interval so that the spaces between the dielectrics 310 and the grounding plates 340 can evenly secured in all the regions.

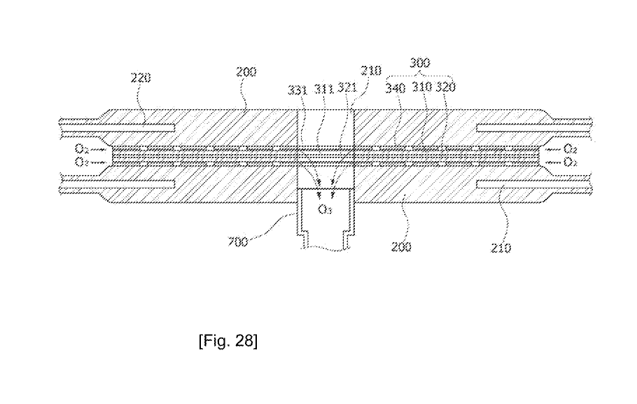

FIG. 27 is an exploded perspective view showing an electric discharge unit 300 and cooling channels 200 included in an ozone generating device according to an eighth embodiment of the present invention. FIG. 28 is a section view of the ozone generating device according to the eighth embodiment of the present invention.

In case where each of the electric discharge units 300 is configured to include the grounding plates 340, the electric discharge units 300 may be provided in multiple numbers as shown in FIG. 3 so that an increased amount of ozone can be generated at one time.

In this case, with a view to gather the ozone generated by the respective electric discharge units 300 in one space, the ozone generating device of the present embodiment may be configured to include: three or more cooling channels 200 each having a through-hole 220 formed in the central region thereof and a coolant flow path 220 formed therein, the cooling channels 200 arranged side by side so that the through-holes 220 can overlap with one another; and electric discharge units 300 interposed between the cooling channels 200 adjoining each other and configured to generate electric discharge when applied with a high voltage from a power supply unit 500, each of the electric discharge units 300 having a central hole formed in alignment with the through-hole 220. In this regard, each of the electric discharge units 300 is formed by stacking the conductive body 320, the dielectrics 310 and the grounding plates 340 as shown in FIG. 27. Each of the conductive body 320, the dielectrics 310 and the grounding plates 340 is formed to have a central hole 302. The central holes 302 of the conductive body 320, the dielectrics 310 and the grounding plates 340 are formed in alignment with the through-holes 220 of the cooling channels 200.

Oxygen need to be supplied to the electric discharge units 300 in order for the electric discharge units 300 to generate ozone. The oxygen is supplied toward the lateral ends, i.e., the outer circumferential surfaces of the electric discharge units 300. The ozone generated by the electric discharge units 300 is gathered in the central holes 302 of the electric discharge units 300 and is discharged out of the chamber 100 through the ozone exhaust pipe 700. In the ozone generating device of the present embodiment, the ozone generated by the electric discharge units 300 is gathered in one space (the internal space defined by the through-holes 220 and the central holes 302). This provides an advantage in that there is no need to employ additional flow paths and pipes for gathering the ozone generated by the respective electric discharge units 300. The process in which oxygen is transformed to ozone while passing through the electric discharge units 300 and the effects provided by stacking the electric discharge units 300 are the same as those already described in the embodiment shown in FIGS. 3 through 18. Therefore, no description will be made in that regard.

While certain preferred embodiments of the invention have been described above, the scope of the present invention is not limited to these embodiments but shall be construed based on the appended claims. It will be apparent to those skilled in the art that various changes, modifications and substitutions may be made without departing from the scope of the invention defined in the claims.

1-33. (canceled)

34. An ozone generating device, comprising:
three or more cooling channels (200) each having a through-hole (210) formed in a central region thereof and a coolant flow path (220) formed therein, the cooling channels (200) arranged side by side such that the through-holes (210) thereof overlap with one another; and
electric discharge units (300) interposed between the cooling channels (200) adjoining each other and configured to generate electric discharge when applied with a high voltage, each of the electric discharge units (300) having a central hole (302) formed in alignment with the through-hole (210),
wherein the ozone generating device is configured such that, when the electric discharge units (300) are applied with a high voltage with the cooling channels (200) kept grounded, oxygen supplied to the electric discharge units (300) is decomposed into ozone which in turn is discharged through an internal space defined by the through-hole (210) and the central hole (302).

35. The ozone generating device of claim 34, further comprising:
a chamber (100) arranged to accommodate the cooling channels (200) and the electric discharge units (300); and
an oxygen supply unit (600) arranged to supply oxygen into the chamber (100).

36. The ozone generating device of claim 35, further comprising:
an ozone exhaust pipe (700) arranged to be connected with the internal space defined by the through-hole (210) and the central hole (302), the ozone exhaust pipe (700) configured to gather the ozone generated by the electric discharge units (300) and to discharge the ozone out of the chamber (100).

37. The ozone generating device of claim 36, wherein the ozone exhaust pipe (700) has a first end portion connected to the through-hole (210) of the cooling channel (200) positioned at one end of the ozone generating device and a second end portion extending out of the chamber (100), the through-hole (210) of the cooling channel (200) positioned at the other end of the ozone generating device kept closed.

38. The ozone generating device of claim 34, further comprising:
a coolant supply pipe (410) parallel-connected to the cooling channels (200); and
a coolant drain pipe (420) parallel-connected to the cooling channels (200);
said the cooling channels (200), the coolant supply pipe (410) and the coolant drain pipe (420) are made of an electrically conductive metal and are configured to serve as grounding terminals.

39. The ozone generating device of claim 34, wherein the cooling channels (200) are stacked such that a longitudinal direction of the through-hole (210) extends along an up-down direction, each of the cooling channels (200) having a planar upper surface and a planar lower surface, each of the electric discharge units (300) formed into a flat shape.

40. The ozone generating device of claim 34, wherein each of the electric discharge units (300) includes a pair of dielectrics (310) making contact with the mutually facing surfaces of the cooling channels (200) adjoining each other and a conductive body (320) arranged between the dielectrics (310).

41. The ozone generating device of claim 34, wherein each of the electric discharge units (300) includes a pair of dielectrics (310) attached to or coated on the mutually facing surfaces of the cooling channels (200) adjoining each other and a conductive body (320) press-fitted to between the dielectrics (310).

42. The ozone generating device of claim 34, wherein each of the electric discharge units (300) includes a dielectric (310) making contact with one of the mutually facing surfaces of the cooling channels (200) adjoining each other and a conductive body (320) arranged between the other of the mutually facing surfaces of the cooling channels (200) adjoining each other and the dielectric (310).

43. The ozone generating device of claim 34, wherein each of the electric discharge units (300) includes a dielectric (310) attached to or coated on one of the mutually facing surfaces of the cooling channels (200) adjoining each other and a conductive body (320) press-fitted to between the other of the mutually facing surfaces of the cooling channels (200) adjoining each other and the dielectric (310).

44. The ozone generating device of any one of claim 40, wherein the conductive body (320) or the dielectric (310) has a surface facing the dielectric (310) and having an arithmetical average roughness Ra of 0.1 to 100 μm or at least one of the mutually facing surfaces of the conductive body (320) and the dielectric (310) is formed into a wavy shape.

45. The ozone generating device of any one of claim 40, wherein each of the electric discharge units (300) further includes one or more spacers (330) arranged between the conductive body (320) and the dielectric (310) so as to keep the conductive body (320) and the dielectric (310) spaced apart from each other.

46. An ozone generating device, comprising:
an electric discharge unit (300) including a conductive body (320) applied with a high voltage, a dielectric (310) having one surface for covering the conductive body (320) and a grounding plate (340) for covering the other surface of the dielectric (310); and
a cooling channel (200) having a coolant flow path (220) and making contact with the grounding plate (340),
wherein the grounding plate (340) includes projections formed on a surface of the grounding plate (340) facing the dielectric (310) so as to secure a space between the dielectric (310) and the grounding plate (340).

47. The ozone generating device of claim 46, wherein the projections are burrs (344) formed on one surface of the grounding plate (340) when the grounding plate (340) is punched from the other surface of the grounding plate (340) toward one surface thereof, or protuberances (346) formed on one surface of the grounding plate (340) when the other surface of the grounding plate (340) is subjected to embossing.

48. The ozone generating device of claim 47, wherein the burrs (344) are formed in multiple numbers at a regular interval on one surface of the grounding plate (340).

49. The ozone generating device of claim 47, wherein the protuberances (346) are formed in multiple numbers at a regular interval on one surface of the grounding plate (340).

50. The ozone generating device of claim 46, wherein the dielectric (310) includes a pair of dielectrics (310) arranged to cover the both surfaces of the conductive body (320), the grounding plate (340) including a pair of grounding plates (340) arranged to cover each dielectric (310).

51. The ozone generating device of any one of claim 46, wherein the cooling channel (200) includes three or more cooling channels (200) each having a through-hole (210) formed in a central region thereof, the cooling channels (200) arranged side by side such that the through-holes (220) thereof overlap with one another, the electric discharge unit (300) including electric discharge units (300) interposed between the cooling channels (200) adjoining each other, each of the electric discharge units (300) having a central hole formed in alignment with the through-hole (220), the ozone generating device configured such that, when the electric discharge units (300) are applied with a high voltage, oxygen supplied to the electric discharge units (300) is decomposed into ozone which in turn is discharged through an internal space defined by the through-hole (220) and the central hole.
